(19) United States
(12) Patent Application Publication
(10) Pub. No.: US 2015/0262097 A1
(43) Pub. Date: Sep. 17, 2015

(54) SYSTEM AND METHOD FOR MODELLING AND SIMULATING A DECISION MAKING PROCESS OF AN ENTERPRISE

(71) Applicant: Tata Consultancy Services Limited, Mumbai (IN)

(72) Inventors: Vinay KULKARNI, Pune (IN); Souvik BARAT, Pune (IN)

(73) Assignee: Tata Consultancy Services Limited

(21) Appl. No.: 14/657,951

(22) Filed: Mar. 13, 2015

(30) Foreign Application Priority Data
Mar. 13, 2014 (IN) 3930/MUM/2013

(51) Int. Cl. G06Q 10/06

(52) U.S. Cl. CPC G06Q 10/0637; G06Q 10/067

(57) ABSTRACT

System and method for modelling and simulating a decision making process of an enterprise is disclosed. Data corresponding to a plurality of units in the enterprise is received. For each unit, a unit configuration may be determined. The unit configuration comprises goals of the unit, a set of internal properties of the unit, a set of functions of the unit, events to be handled by the unit, and a composition structure of one or more units to interact with other units of the plurality of units participating to perform a task. Further, a plurality of tuples is specified for the unit configuration. The plurality of tuples of the unit configuration is translated into an executable programming language. Subsequently, the unit configuration is simulated using the executable programming language to analyze decision making of the enterprise corresponding to the plurality of units for the unit configuration.

### CROSS REFERENCE TO RELATED APPLICATIONS

The present application claims priority to an Indian Provisional Patent Application No. 3930/MUM/2013, filed on Mar. 13, 2014, the entirety of which is hereby incorporated by reference.

### TECHNICAL FIELD

The present disclosure in general relates to a field of modelling aspects of an enterprise. More particularly, the present disclosure relates to a system and a method for modelling and simulating a decision making process of an enterprise.

### BACKGROUND

Typically, an enterprise may be specified in terms of a set of models in order to understand and analyze various aspects of the enterprise. Modelling of an enterprise may enable key decision makers of the enterprise to understand current aspects of the enterprise, possible improvements and a precise justification of the futuristic initiatives comprising optimization, transformation, merger or acquisition. There exist several tools facilitating modelling of the enterprise. However, the models available today are descriptive in nature. Therefore, the models require a human expertise to analyze and interpret aspects of the enterprise. The need of the human expertise may lead to an undesirable latency in responding to and implementing changes in the enterprise. Also, the human expertise may depend on past experience and may not be able to address problems arising in future. As a result, the enterprises have been struggling to deal with business-critical concerns comprising Business-IT alignment, IT systems rationalization and Enterprise transformation.

Moreover, specification of the models and subsequent infrastructure required to analyze, simulate, and implement the models correlate only “what” and “how” aspects of the enterprise. The specification used in the models may not be useful to analyze an intention of the enterprise, i.e., current state of the enterprise and a to-be enterprise. Further, the specification of the existing models may be defined only for a specific layer of abstraction, such as Business layer, Systems layer or Application layer. The specific layer of abstraction may result in incomplete information to understand the enterprise at a given point of time, and insufficient data points to understand the to-be enterprise.

### SUMMARY

This summary is provided to introduce concepts related to systems and methods for modelling and simulating a decision making process of an enterprise and the concepts are further described below in the detailed description. This summary is not intended to identify essential features of the claimed subject matter nor is it intended for use in determining or limiting the scope of the claimed subject matter.

In one implementation, a method for modelling and simulating a decision making process of an enterprise is disclosed. The method comprises receiving data corresponding to a plurality of units in an enterprise. A unit in the plurality of units performs at least one task to achieve at least one goal of the enterprise. The method further comprises determining a unit configuration comprising goals of the unit, a set of internal properties of the unit, a set of functions of the unit, events to be handled by the unit, a composition structure of one or more units to interact with other units of the plurality of units participating to perform a task, a behaviour of the one or more units utilizing other units to achieve the goals, and parametric properties influencing the goals and the behaviour of the units. The method further comprises specifying a plurality of tuples for the unit configuration. The method further comprises translating, by a processor, the plurality of tuples of the unit configuration into an executable programming language. The method further comprises simulating, by the processor, the unit configuration using the executable programming language to analyze decision making of the enterprise corresponding to the plurality of units for the unit configuration.

In one implementation, a system for modelling and simulating a decision making process of an enterprise is disclosed. The system comprises a memory and a processor coupled to the memory. The processor executes program instructions stored in the memory to receive data corresponding to a plurality of units in an enterprise. A unit in the plurality of units performs at least one task to achieve at least one goal of the enterprise. The processor further executes the program instructions to determine a unit configuration comprising goals of the unit, a set of internal properties of the unit, a set of functions of the unit, events to be handled by the unit, a composition structure of one or more units to interact with other units of the plurality of units participating to perform a task, a behaviour of the one or more units utilizing other units to achieve the goals, and parametric properties influencing the goals and the behaviour of the units. The processor further executes the program instructions to specify a plurality of tuples for the unit configuration. The processor further executes the program instructions to translate the plurality of tuples of the unit configuration into an executable programming language. The processor further executes the program instructions to simulate the unit configuration using the executable programming language to analyze decision making of the enterprise corresponding to the plurality of units for the unit configuration.

In one implementation, a non-transitory computer readable medium embodying a program executable in a computing device for modelling and simulating a decision making process of an enterprise is disclosed. The program comprises a program code for receiving data corresponding to a plurality of units in an enterprise. A unit in the plurality of units performs at least one task to achieve at least one goal of the enterprise. The program further comprises a program code for determining a unit configuration comprising goals of the unit, a set of internal properties of the unit, a set of functions of the unit, events to be handled by the unit, a composition structure of one or more units to interact with other units of the plurality of units participating to perform a task, a behaviour of the one or more units utilizing other units to achieve the goals, and parametric properties influencing the goals and the behaviour of the units. The program further comprises a program code for specifying a plurality of tuples for the unit configuration. The program further comprises a program code for translating the plurality of tuples of the configuration into an executable programming language. The program further comprises a program code for simulating the unit configuration using the executable programming language to analyze decision making of the enterprise corresponding to the plurality of units for the unit configuration.

### BRIEF DESCRIPTION OF DRAWINGS

The detailed description is described with reference to the accompanying figures. In the figures, the left-most digit(s) of a reference number identifies the figure in which the reference number first appears. The same numbers are used throughout the drawings to refer like/similar features and components.

FIG. 1 illustrates a network implementation of a system for modelling and simulating a decision making process of an enterprise, in accordance with an embodiment of the present disclosure.

FIG. 2 illustrates the system, in accordance with an embodiment of the present disclosure.

FIG. 3 shows a method for modelling a plurality of units in an enterprise, in accordance with an embodiment of the present disclosure.

FIG. 4 shows a flowchart for modelling and simulating a decision making process of an enterprise, in accordance with an embodiment of the present disclosure.

### DETAILED DESCRIPTION

The present disclosure relates to a system and a method for modelling and simulating a decision making process of an enterprise. In some embodiments, data corresponding to a plurality of units in an enterprise may be received. A unit in the plurality of units may perform at least one task to achieve at least one goal of the enterprise. The plurality of units may comprise one of an organizational unit, people, and an infrastructure unit. In one example, the at least one task may comprise one of sending an event, receiving an event, and performing a function, by the unit. For each of the unit, a unit configuration may be determined. In one example, the unit configuration may comprise goals of the unit, a set of internal properties of the unit, a set of functions of the unit, events to be handled by the unit, a composition structure of one or more units to interact with other units of the plurality of units participating to perform a task, a behaviour of the one or more units utilizing other units to achieve the goals, and parametric properties influencing the goals and the behaviour of the units. For the unit configuration, a plurality of tuples may be specified.

Subsequently, the plurality of tuples corresponding to the unit configuration may be translated into an executable programming language. In one example, the executable programming language may be a kernel language. The unit configuration may be simulated using the executable programming language to analyze decision making of the enterprise corresponding to the plurality of units for the unit configuration.

While aspects of described system and method for modelling and simulating a decision making process of an enterprise may be implemented in any number of different computing systems, environments, and/or configurations, the embodiments are described in the context of the following exemplary system.

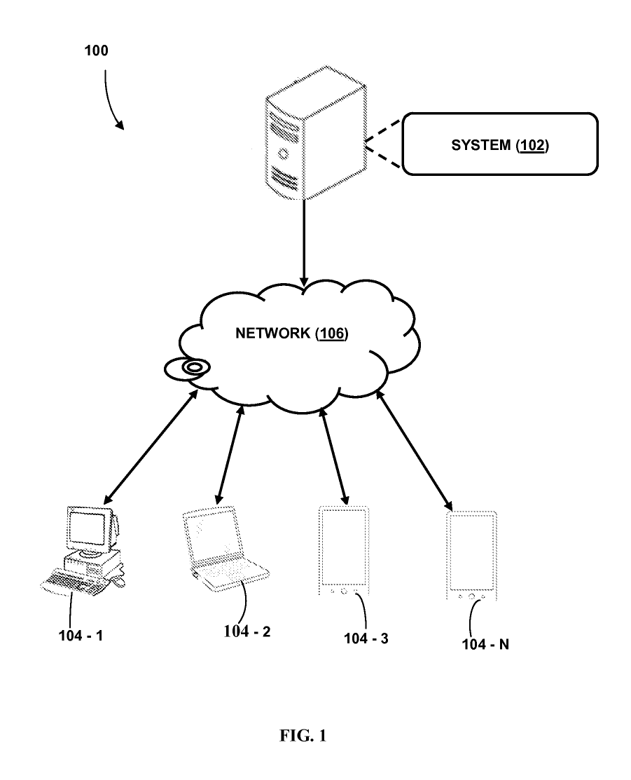

Referring now to FIG. 1, a network implementation 100 of a system 102 for modelling and simulating a decision making process of an enterprise is illustrated, in accordance with an embodiment of the present disclosure. The system 102 may receive data corresponding to a plurality of units in an enterprise. A unit in the plurality of units may perform at least one task to achieve at least one goal of the enterprise. The system 102 may determine a unit configuration comprising goals of the unit, a set of internal properties of the unit, a set of functions of the unit, events to be handled by the unit, a composition structure of one or more units to interact with other units of the plurality of units participating to perform a task, a behaviour of the one or more units utilizing other units to achieve the goals, and parametric properties influencing the goals and the behaviour of the units. Further, the system 102 may specify a plurality of tuples for the unit configuration. The system 102 may translate the plurality of tuples of the unit configuration into an executable programming language. Subsequently, the system 102 may simulate the unit configuration using the executable programming language to analyze decision making of the enterprise corresponding to the plurality of units for the unit configuration.

Although the present disclosure is explained by considering that the system 102 is implemented on a server, it may be understood that the system 102 may also be implemented in a variety of computing systems, such as a laptop computer, a desktop computer, a notebook, a workstation, a mainframe computer, a server, a network server, cloud, and the like. It will be understood that the system 102 may be accessed by multiple users through one or more user devices 104-1, 104-2 . . . 104-N, collectively referred to as user devices 104 hereinafter, or applications residing on the user devices 104. Examples of the user devices 104 may include, but are not limited to, a portable computer, a personal digital assistant, a handheld device, and a workstation. The user devices 104 are communicatively coupled to the system 102 through a network 106.

In one implementation, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

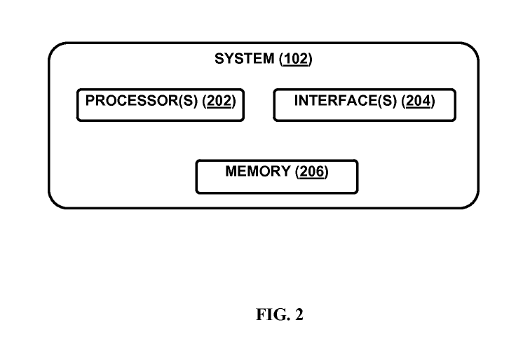

Referring now to FIG. 2, the system 102 is illustrated in accordance with an embodiment of the present disclosure. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions stored in the memory 206.

The I/O interface 204 may include a variety of software and hardware interfaces, for example, a web interface, a graphical user interface, and the like. The I/O interface 204 may allow the system 102 to interact with a user directly or through the user devices 104. Further, the I/O interface 204 may enable the system 102 to communicate with other computing devices, such as web servers and external data servers (not shown). The I/O interface 204 may facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes.

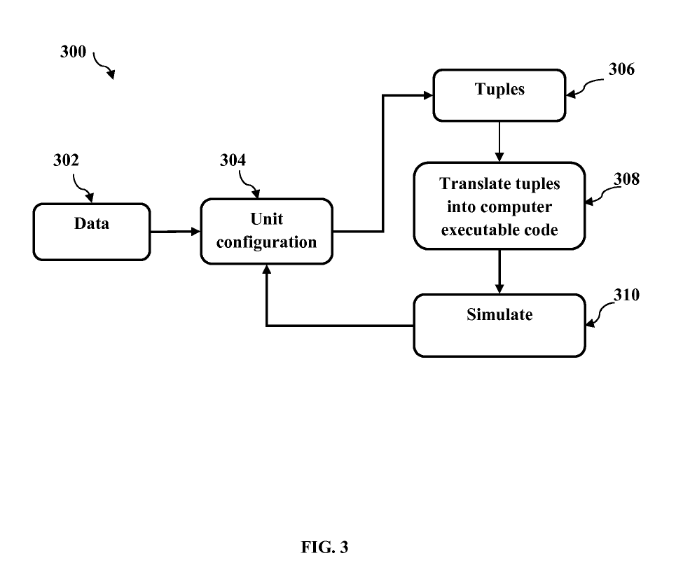

In one implementation, at first, the user may use the client device 104 to access the system 102 via the I/O interface 204. The working of the system 102 may be explained in detail using FIG. 3. Referring to FIG. 3, a method 300 for modelling a decision making process of an enterprise is illustrated. The system 102 may be used for modelling and simulating a decision making process of an enterprise. In order to model the decision making process of the enterprise, the system 102 may receive data corresponding to a plurality of units in the enterprise, as shown at step 302. In one example, the plurality of units may comprise one of an organizational unit, people, and an infrastructure unit. The people may indicate personnel available in the enterprise. The organizational unit may indicate essential business functions in the enterprise that are divided to maximize efficiency. In other words, the people in the enterprise may be divided to create separate departments, such as for marketing, sales, accounting, information technology, and so on. In one example, the people may be divided or classified in a hierarchy such as a Manager, an Assistant Manager, an executive, and so on. In another example, the people may be divided based on a project team, groups, and departments. The infrastructure unit may indicate resources that are available in the enterprise. The resources may include, but not limited to, computers, servers, data centres, and so on. The resources may be associated with policies and strategies pre-defined for the enterprise.

The data corresponding to each unit of the plurality of units may be received based on a structure of the enterprise. In one example, the enterprise may include, but not limited to, an educational institution, data centre, and an Information Technology firm. In one example, the structure of the enterprise may include multiple departments with limited people in each department. In another example, the structure of the enterprise may include manufacturing unit, management, human resource department, and so on.

A unit in the plurality of units may perform at least one task to achieve at least one goal of the enterprise. In one example, the at least one task may comprise one of sending an event, receiving an event, and performing a function, by the unit. It is to be understood that each unit may have at least one goal for themselves. Further, each unit of the plurality of units may have at least one goal for the enterprise. For example, a goal for the manager may include completing a project on time with available people. Similarly, a goal for the enterprise may include completing the project without additional cost within a specified time and with the people available. In order to explain the unit performing a task, an example may be used. Consider the hierarchy of the organizational unit as manager, assistant manager and executive. Consider, the manager allots a project to two assistant managers and each assistant manager has ten executives to work on the project. The manager may divide the people in the enterprise. For example, the manager may divide the people between project teams, groups, or departments based on a task. In one example, the executive may be assigned a task to write a software code for an application. Similarly, the assistant manager may be assigned a task to review the software code. Similarly, each unit in the plurality of units performs at least one task to achieve the goals themselves and that of the enterprise.

Based on the data received for the enterprise, a unit configuration for each unit may be determined, as shown at step 304. The unit configuration may indicate a specification determined for the unit to behave in a particular manner. The unit configuration may be determined for the plurality of units to create a model for decision making in the enterprise. Specifically, the model may be created to understand behaviour of the enterprise to achieve the goals. In one example, the unit configuration may be determined using an enterprise taxonomy selected from a library of the enterprise. In another example, the unit configuration may be determined by the plurality of units themselves. In one example, the unit configuration for the plurality of units may be determined using a pre-defined specification from the library of the enterprise. In one example, the manager may determine the unit configuration for himself. In another example, the manager may determine the unit configuration for the assistant manager. Similarly, one unit may determine the unit configuration for other units in the enterprise.

In one example, the unit configuration may include, but not limited to, goals of the unit, a set of internal properties of the unit, a set of functions of the unit, events to be handled by the unit, a composition structure of one or more units to interact with other units of the plurality of units participating to perform a task, a behaviour of the one or more units utilizing other units to achieve the goals, and parametric properties influencing the goals and the behaviour of the units.

The goals of the unit may indicate a target set or an objective defined to perform the task. In one example, the goal may be set with a degree of certainty. For example, the executive may have a goal set that includes completing a given project in ten days with 95% of certainty. The set of internal properties of the unit may indicate ability of the unit to perform a given task. For example, the internal property of the executive may include his experience in performing a given task. In another example, the internal property of the executive may include time the executive takes to complete a given task.

The events to be handled may indicate the task that the unit is required to perform. For example, the executive may have a task of writing a software code for an application. For writing the software code, the assistant manager may provide instructions to the executive. Providing the instructions may indicate sending an event for the assistant manager. Subsequently, the executive may receive the instructions from the assistant manager. Receiving of the instructions may indicate receiving an event for the executive. After receiving the instructions, the executive may write the software code for the application. Writing the software code may indicate performing a function by the executive. In one example, the units may be provided with constraints to perform the task. For example, the executive may have a constraint such that the executive should not initiate writing the software code without receiving the instructions from the assistant manager. In other words, subsequent event should not be initiated by a next unit before completion of previous event by another unit.

The composition structure may indicate a group of units pooled together to perform a task. For the above example, one or more executives under the assistant manager may form a group to write the software code. The behaviour may indicate the one or more units utilizing other units in the plurality of units to achieve the goals. The one or more units may utilize other units to achieve respective goals and the goals of the enterprise. In one example, consider the enterprise has multiple departments comprising a marketing department and a sales department. The marketing department may have one or more units, i.e., people to perform one or more tasks. Similarly, the sales department may have one or more units, i.e., people to perform one or more tasks. Consider the goal of the enterprise is to increase sales of the enterprise. In order to achieve the goal of the enterprise, the one or more units in the marketing department may utilize the one or more units in the sales department.

The parametric property may indicate a property of the unit that cannot be expressed as a single name. The parametric property may have values specified to evaluate the goals set for the units. In other words, the parametric property may correspond to a range within which the values of the unit are present. In order to explain the parametric property, an example may be used. Consider the time taken by the executive to write the software code is in a range of one hour to two hour. If the executive does not write the software code in the range defined, then other executives receiving the event (subsequent event) from the executive may have an impact on their goals.

In one implementation, the system 102 may utilize a component interface (not shown) to receive the unit configuration from the user. The component interface may be used to state the goals of the unit, expectations from the unit, and the interactions to be made by the unit with other units. In one example, the expectations from the unit may be stated with a quality of service guarantee. The expectations from the unit may be stated with the quality of service guarantee to provide a negotiating lever. Each unit in the one or more units may have same goal and same unit configurations. Further, each unit may have different quality of service and different expectations for delivering the quality as may be promised by the unit. In one implementation, the one or more units may have a hierarchical composition structure to achieve the goals of the enterprise. In order to achieve the goals of the enterprise, the expectations from the one or more units may be provided with the quality of service guarantee.

After determining the unit configuration, the system 102 may specify a plurality of tuples for the unit configuration, as shown at step 306. In one implementation, the component interface may be used to specify the plurality of tuples. In one example, a tuple may be defined as <inEvent, outEvent, xGoal, Conf>.

An inEvent may indicate a set of events of interest to the one or more units. An outEvent may indicate a set of events generated by the one or more units. An xGoal may indicate the goals of the one or more units that are observable. A Conf may indicate a set of configuration variants that conform to the InEvent, the OutEvent, and the xGoal. Further, the Conf may comprise a tuple defined as <Expect,QoS>. An Expect may indicate a set of expectations from the one or more units expressed as name-value expression pairs. A Quality of Service (QoS) may indicate a set of QoS properties guaranteed by the one or units provided the expectations defined in the Expect are met.

For each unit, the unit configuration may be specified in the plurality of tuples to execute the tasks by the one or more units in the enterprise. In one example, the execution of the tasks by the one or more units may be specified as a tuple, such as <iGoal,P,F,T,Content,iEvent>. An iGoal may indicate an internal goal of the one or more units. P may indicate a set of properties or attributes of the one or more units. F may indicate a set of functions performed by the unit. T may indicate a recorded trace of the events that have been consumed and produced by the unit. Content may indicate a set of other units in the plurality of units interacting with the one or more units. An iEvent may indicate a set of internal events through which the one or more units interact with other units.

Execution of the tasks by one or more units may be important to understand variants of the one or more units as specified in the Conf. During execution, the one or more units may respond to the inEvent set of events, may raise the outEvent set of events, and may orchestrate the Content set of other units to achieve the iGoal as stated. Further, the system 102 may record the events of interest occurred and changes to the properties of the one or more units. In other words, the system 102 may capture behaviour of the one or more units, i.e., the set of event handlers for all of the inEvents.

For the events, each Event may be defined as a tuple, such as <Name, EP, preCond, postCond>. Name may indicate a label to identify the unit. EP may indicate a set of properties or attributes of the event. A preCond may indicate a condition that should be fulfilled to recognize the event. A postCond may indicate a condition that should hold true after completion of the event. The preCond and the postCond may be the expressions over the events and the properties of the event.

For the goals, each goal may be defined as a tuple, such as <Name, GExpr>. Name may indicate a label to identify the unit. GExpr may indicate one of a property expression (PExpr), an event expression (EExpr), and a goal composition expression (GCExpr). The property expression may be a value expression over the properties of P and EP. The event expression may be a linear temporal logic or linear-time temporal logic (LTL) formulae over the events, and the goal composition expression may use a set of composition operators over the goal expressions. The goal composition expression may enable the unit configuration with limited uncertainty and non-determinism in the goal expression.

By specifying the plurality of tuples for the unit configuration in a core language, such as goal, state, event, interface, component, composition, negotiation, and uncertainty, the enterprise may enable decision making based on a scenario using the unit configuration determined for the plurality of units in the enterprise.

After specifying the plurality of tuples for the unit configuration, the system 102 may translate the plurality of tuples into an executable programming language, as shown at step 308. In other words, the plurality of tuples may be translated into a script. In one example the executable programming language may be a kernel language. The executable programming language may be used as a working model for the enterprise.

The executable programming language may be codified to form communicating data between the plurality of units in the enterprise. The executable programming language may be used define and enforce the unit configuration of each unit in the enterprise. For example, the executable programming language may be used to define the events to be handled by each unit in the enterprise. In another example, the executable programming language may be used to define the parametric properties influencing the goals and the behaviour of the units to perform a task.

After translating the plurality of tuples into the executable programming language, the system 102 may simulate the unit configuration using the executable programming language to analyze decision making of the enterprise, as shown at step 310. In one example, the system 102 may simulate the unit configuration of the plurality of the units in the enterprise. In one example, the system 102 may act on the unit configuration communicated from any unit in real time. Alternatively, the executable programming language may be conditioned such that the system 102 have to wait until the data from the plurality of units is received before continuing.

Simulating the unit configuration using the executable programming language is explained in greater detail. The unit configuration determined for the plurality of units may be made available to the system 102. After receiving the unit configuration, the system 102 may generate the executable programming language. Upon generation, the executable programming language may include the goals of the each unit, the set of internal properties of each unit, the set of functions of each unit, the events to be handled by each unit, the composition structure of one or more units, in the form of the script that may be applied during the simulation. The executable programming language may include one or more stages of execution to analyze the decision making process of the enterprise.

In one implementation, the system 102 may compile the executable programming language on the fly, i.e., interpretive execution. In another implementation, the system 102 may compile the executable programming language into a data structure that may be used to execute at a later stage.

After simulating the unit configuration of the plurality of units, a behavioural outcome of the enterprise may be obtained. The behavioural outcome may indicate performance of the plurality of units in the enterprise based on the unit configuration determined. In one example, the behavioural outcome may be obtained for the plurality of units in the enterprise. In another example, the behavioural outcome may be obtained for each unit in the enterprise. The behavioural outcome may be displayed on the I/O interface 204. The behavioural outcome may be displayed in a form of charts. In one example, the behavioural outcome may be displayed for a specific unit in the enterprise. After obtaining the behavioural outcome, the decision making process of the enterprise may be analyzed. Specifically, the behavioural outcome is analyzed to check the performance of the enterprise with the desired objectives set for the units and for the enterprise. In other words, the behavioural outcome of the enterprise may be analyzed by comparing the behavioural outcome with the expectations of the plurality of units. Similarly, the behavioural outcome of the each unit may be analyzed by comparing the behavioural outcome with the expectations of the unit.

Based on the analysis, if the unit configuration of the unit is found to be inappropriate with the desired objectives, then the unit configuration of the unit may be changed. For example, consider the infrastructure unit was inappropriate for the people to complete a project within the specified time. Based on the analysis, the unit configuration of the infrastructure unit may be changed. After changing the unit configuration of the infrastructure unit, the system 102 may run the simulation again to obtain the behavioural outcome. Subsequently, the behavioural outcome may be analyzed and the unit configuration may be changed repeatedly until an optimal configuration is obtained. The optimum configuration may indicate a unit configuration that may be ideal for the plurality of units to achieve individual goals and the goals of the enterprise.

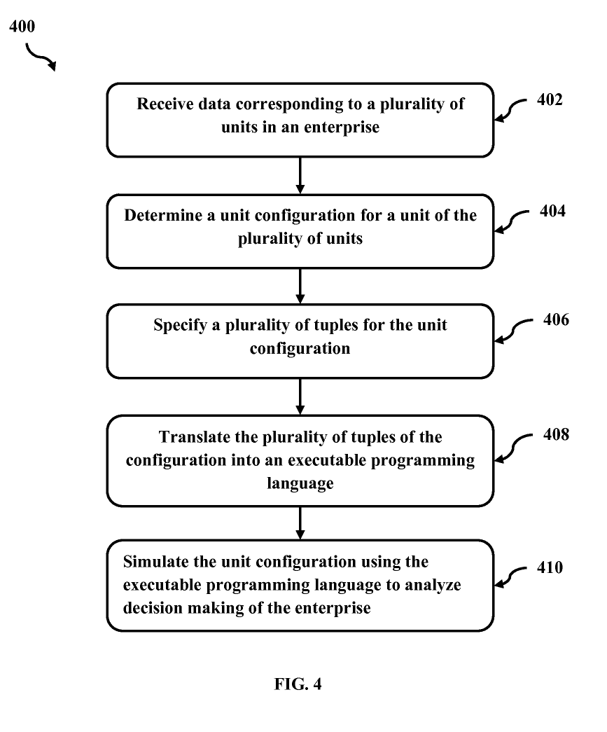

Referring now to FIG. 4, a method 400 for modelling and simulating a decision making process of an enterprise is shown, in accordance with an embodiment of the present disclosure. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described and is not intended to be construed as a limitation, and any number of the described method blocks can be combined in any order to implement the method 400 or alternate methods. Additionally, individual blocks may be deleted from the method 400 without departing from the spirit and scope of the disclosure described herein. Furthermore, the method may be implemented in any suitable hardware, software, firmware, or combination thereof. However, for ease of explanation, in the embodiments described below, the method 400 may be implemented in the above-described system 102.

At step/block 402, data corresponding to a plurality of units in an enterprise may be received. A unit in the plurality of units may perform at least one task to achieve at least one goal of the enterprise.

At step/block 404, a unit configuration comprising goals of the unit, a set of internal properties of the unit, a set of functions of the unit, events to be handled by the unit, a composition structure of one or more units to interact with other units of the plurality of units participating to perform a task, a behaviour of the one or more units utilizing other units to achieve the goals, and parametric properties influencing the goals and the behaviour of the units may be determined.

At step/block 406, a plurality of tuples may be specified for the unit configuration.

At step/block 408, the plurality of tuples of the configuration may be translated into an executable programming language.

At step/block 410, the unit configuration may be simulated using the executable programming language to analyze decision making of the enterprise corresponding to the plurality of units for the unit configuration.

Although implementations of system and method modelling and simulating a decision making process of an enterprise have been described in language specific to structural features and/or methods, it is to be understood that the appended claims are not necessarily limited to the specific features or methods described. Rather, the specific features and methods are disclosed as examples of implementations for searching a document in a plurality of nodes.

1. A method for modelling and simulating a decision making process of an enterprise, the method comprising:
receiving, via a hardware processor, data corresponding to a plurality of units in an enterprise, wherein a unit in the plurality of units performs at least one task to achieve at least one goal of the enterprise;
determining, via the hardware processor, a unit configuration comprising goals of the unit, a set of internal properties of the unit, a set of functions of the unit, events to be handled by the unit, a composition structure of one or more units to interact with other units of the plurality of units participating to perform a task, a behavior of the one or more units utilizing other units to achieve the goals, and parametric properties influencing the goals and the behavior of the units;
specifying, via the hardware processor, a plurality of tuples for the unit configuration;
translating, via the hardware processor, the plurality of tuples of the unit configuration into an executable programming language; and
simulating, via the hardware processor, the unit configuration using the executable programming language to analyze decision making of the enterprise corresponding to the plurality of units for the unit configuration.

2. The method of claim 1, wherein the executable programming language is a kernel language.

3. The method of claim 1, wherein the plurality of units comprise one of an organizational unit, people, and an infrastructure unit.

4. The method of claim 1, wherein the at least one task comprise one of sending an event, receiving an event, and performing a function, by the unit.

5. The method of claim 1, wherein the unit configuration is determined with a degree of certainty.

6. The method of claim 1, further comprising specifying values for the parametric properties to evaluate the goals set for the unit.

7. The method for claim 1, further comprising obtaining an optimal unit configuration to achieve the goals with a degree of certainty based on the simulation.

8. A system for modelling and simulating a decision making process of an enterprise, the system comprising:
a memory; and
a hardware processor coupled to the memory, wherein the hardware processor executes program instructions stored in the memory, to:
receive data corresponding to a plurality of units in an enterprise, wherein a unit in the plurality of units performs at least one task to achieve at least one goal of the enterprise;
determine a unit configuration comprising goals of the unit, a set of internal properties of the unit, a set of functions of the unit, events to be handled by the unit, a composition structure of one or more units to interact with other units of the plurality of units participating to perform a task, a behavior of the one or more units utilizing other units to achieve the goals, and parametric properties influencing the goals and the behavior of the units;
specify a plurality of tuples for the unit configuration;
translate the plurality of tuples of the configuration into an executable programming language; and
simulate the unit configuration using the executable programming language to analyze decision making of the enterprise corresponding to the plurality of units for the unit configuration.

9. The system of claim 8, wherein the executable programming language is a kernel language.

10. The system of claim 8, wherein the plurality of units comprise one of an organizational unit, people, and an infrastructure unit

11. The system of claim 8, wherein the at least one task comprise one of sending an event, receiving an event, and performing a function, by the unit.

12. The system of claim 8, wherein the unit configuration is determined with a degree of certainty.

13. The system of claim 8, wherein the hardware processor further executes the program instruction to obtain an optimal unit configuration to achieve the goals with a degree of certainty based on the simulation.

14. A non-transitory computer readable medium embodying a program executable in a computing device for modelling and simulating a decision making process of an enterprise, the program comprising program code for:
receiving data corresponding to a plurality of units in an enterprise, wherein a unit in the plurality of units performs at least one task to achieve at least one goal of the enterprise;
determining a unit configuration comprising goals of the unit, a set of internal properties of the unit, a set of functions of the unit, events to be handled by the unit, a composition structure of one or more units to interact with other units of the plurality of units participating to perform a task, a behavior of the one or more units utilizing other units to achieve the goals, and parametric properties influencing the goals and the behavior of the units;
specifying a plurality of tuples for the unit configuration;
translating the plurality of tuples of the unit configuration into an executable programming language; and
simulating the unit configuration using the executable programming language to analyze decision making of the enterprise corresponding to the plurality of units for the unit configuration.
